(19) United States
(12) Patent Application Publication
(10) Pub. No.: US 2011/0313792 A1
(43) Pub. Date: Dec. 22, 2011

(54) System and Method for a Records Management and Permissioning System

(75) Inventor: James R. Mault, Evergreen, CO (US)

(73) Assignee: MYTELEHEALTHSOLUTIONS, LLC, La Jolla, CA (US)

(21) Appl. No.: 13/163,547

(22) Filed: Jun. 17, 2011

Related U.S. Application Data
(60) Provisional application No. 61/356,448, filed on Jun. 18, 2010.
(60) Provisional application No. 61/356,452, filed on Jun. 18, 2010.
(60) Provisional application No. 61/356,456, filed on Jun. 18, 2010.
(60) Provisional application No. 61/356,509, filed on Jun. 18, 2010.

(51) Int. Cl. G06Q 50/00

(52) U.S. Cl. 705/3

(57) ABSTRACT

Systems and methods for providing document management. The method includes managing a first record associated with a patient, wherein the patient controls access to the first record. In addition, a second record is managed, wherein the second record is associated with the patient. A health care provider providing care to the patient controls access to the second record. Access to the first record by the health care provider is allowed when the patient grants permission. Also, access to the second record by the patient is allowed when the health care provider grants permission. Both the first and second records are aligned during the period of mutual access.

### CROSS REFERENCE TO RELATED APPLICATIONS

The present application claims priority to and the benefit of U.S. Provisional Patent Application No. 61/356,448, entitled “System and Method for Connected Health Scheduling,” filed on Jun. 18, 2010, which is herein incorporated by reference in its entirety; claims priority to and the benefit of U.S. Provisional Patent Application No. 61/356,452, filed on Jun. 18, 2010, entitled “System and Method for a Health Campaign Manager,” which is herein incorporated by reference in its entirety; claims priority to and the benefit of U.S. Provisional Patent Application No. 61/356,456, filed Jun. 18, 2010, entitled “System and Method for a Single Session Assessment Tool,” which is herein incorporated by reference in its entirety; and claims priority to and the benefit of U.S. Provisional Patent Application No. 61/356,509, filed Jun. 18, 2010, entitled “System and Method for a Records Management and Permissioning System,” which is herein incorporated by reference in its entirety. The present application is related to of U.S. patent application Ser. No. 12/899,522, filed on Oct. 6, 2010, and entitled “System And Method For An Online Platform Distributing Condition Specific Programs Used For Monitoring The Health Of A Participant And For Offering Health Services To Participating Subscribers,” which is herein incorporated by reference in its entirety.

### BACKGROUND

1. Field

The present invention relates to providing health care and more specifically to the implementation of an records management system for health care records providing a central, secure storage of medical records for a multitude of healthcare providers while allowing individualized access to entities requiring access to the healthcare records.

2. The Relevant Technology

The medical industry welcomes new ways to provide better care for individuals and for groups of individuals. As part of the care provided to individuals, healthcare providers must maintain records related to a patient. In addition, government regulations regulate how these records may be shared. It is desirous to explore solutions to provide simple storage and access of records while at the same time limiting access to the records in accordance with applicable regulations.

### SUMMARY

The present invention relates to the field of providing medical services. Specifically, embodiments of the present invention provide for the management of one or more records associated with a patient. For instance, a first record associated with a patient is managed by a records management system, wherein the patient controls access to the first record. In addition, a second record is managed by the same records management system, wherein the second record is also associated with the patient. As an example, a health care provider providing care to the patient controls access to the second record. Access to the first record by the health care provider is allowed when the patient grants permission. Access to the second record by the patient is allowed when the health care provider grants permission.

In one embodiment, both the first and second records are aligned during the period of mutual access. That is, since the first and second records are managed by the records management and permissioning system, both records can be updated with the most current information from both records. More particularly, the first record may be updated with information from the second record, and the second record may be updated with information from the first record. In addition, inconsistencies between the first and second records are corrected when aligning the two records.

### BRIEF DESCRIPTION OF THE DRAWINGS

Exemplary embodiments are illustrated in referenced figures of the drawings which illustrate what is regarded as the preferred embodiments presently contemplated. It is intended that the embodiments and figures disclosed herein are to be considered illustrative rather than limiting.

FIG. 1 is an illustration of a system managing more than one record associated with a patient, in accordance with one embodiment of the present invention.

FIG. 2 is an illustration of the merging and unmerging of two records associated with a patient, in accordance with one embodiment of the present invention.

### DETAILED DESCRIPTION

Reference will now be made in detail to the preferred embodiments of the present invention, a system and method for managing and granting access to two or more reports associated with a patient. While the invention will be described in conjunction with the preferred embodiments, it will be understood that they are not intended to limit the invention to these embodiments. On the contrary, the invention is intended to cover alternatives, modifications and equivalents which may be included within the spirit and scope of the invention as defined by the appended claims.

Accordingly, embodiments of the present invention provide for systems and methods for providing simultaneous and independent management and access to more than one report associated with a patient. In addition, embodiments of the present invention provide for the merging of the more than one report associated with a patient. As a result, embodiments of the present invention provide for patient access to medical records maintained by a health care provider through the records management and permissioning system, as long as the patient is granted access.

### 1. Notation and Nomenclature

Embodiments of the present invention can be implemented on software running on a computer system. The computer system can be a personal computer, notebook computer, server computer, mainframe, networked computer, handheld computer, personal digital assistant, workstation, a network of computers, and the like. In one embodiment, the computer system includes a processor coupled to a bus and memory storage coupled to the bus. The memory storage can be volatile or non-volatile and can include removable storage media. The computer can also include a display, provision for data input and output, etc.

Some portions of the detailed descriptions that follow are presented in terms of procedures, steps, logic block, processing, and other symbolic representations of operations on data bits that can be performed on computer memory. These descriptions and representations are the means used by those skilled in the data processing arts to most effectively convey the substance of their work to others skilled in the art. A procedure, computer executed step, logic block, process, etc. is here, and generally, conceived to be a self-consistent sequence of operations or instructions leading to a desired result. The operations are those requiring physical manipulations of physical quantities. Usually, though not necessarily, these quantities take the form of electrical or magnetic signals capable of being stored, transferred, combined, compared, and otherwise manipulated in a computer system. It has proven convenient at times, principally for reasons of common usage, to refer to these signals as bits, values, elements, symbols, characters, terms, numbers or the like.

It should be borne in mind, however, that all of these and similar terms are to be associated with the appropriate physical quantities and are merely convenient labels applied to these quantities. Unless specifically stated otherwise as apparent from the following discussions, it is appreciated that throughout the present invention, discussions utilizing terms such as “managing,” “allowing,” “providing,” or the like refer to the actions and processes of a computer system, or similar electronic computing device, including an embedded system, that manipulates and transfers data represented as physical (electronic) quantities within the computer system's registers and memories into other data similarly represented as physical quantities within the computer system memories or registers or other such information storage, transmission or display devices.

### 2. Document Management

Embodiments of the present invention provide for the management of records associated with a patient at a central location. In particular, one or more records that are associated with a patient are maintained and managed by one or more entities, such as by the patient, and by one or more health care providers. Normally, the records are independent of each other, however, in embodiments of the present invention, the records can be merged at times when permission is granted, and unmerged when permission is removed. In addition, the records may be aligned during periods of open access.

In one embodiment, the information that is collected and displayed is in compliance with the Health Insurance Portability and Accountability Act of 1996 (HIPAA) and its derivatives.

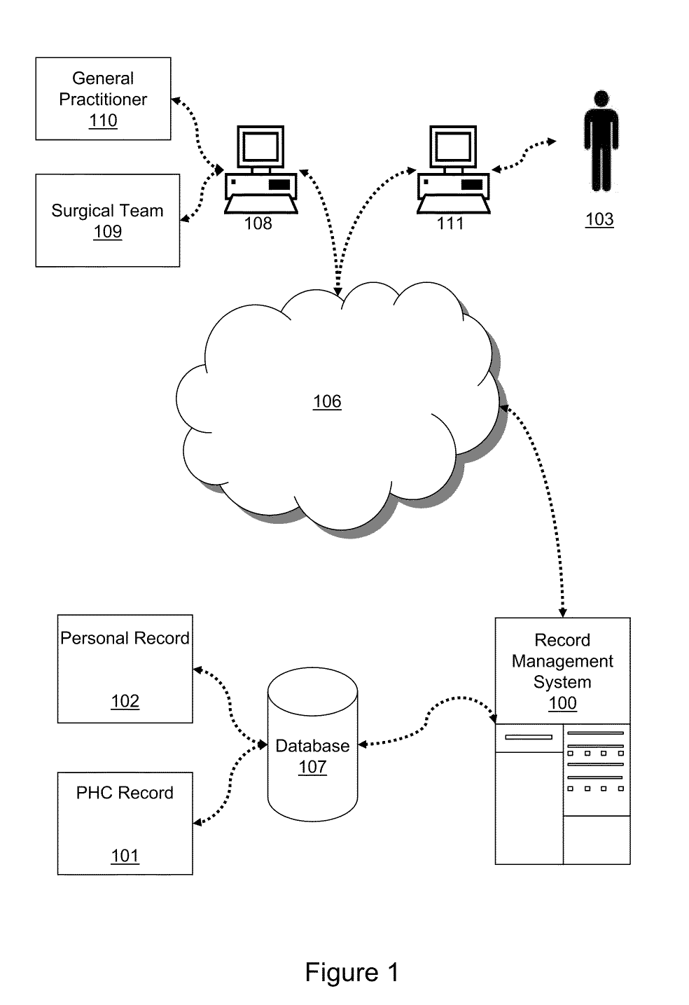

FIG. 1 is a diagram illustrating a system configured to provide the management of one or more records associated with a patient 103, in accordance with one embodiment of the present invention. The records management and permissioning system 100 is centrally located in that it provides management of records that are associated with the patient 103 for more than one entity, rather than having each entity manage its own records for the patient 103.

In one embodiment, the records management and permissioning system 100 is implemented through a network 106, such as a the internet. For instance, a health care provider, such as a general practitioner 110, and a patient 103 communicate through the network 106 with the records management and permissioning system 100 to maintain and update records associated with and concerning the patient 103.

As shown in FIG. 1, the general practitioner 105 communicates with the records management and permissioning system 100 to maintain a first record 101 (PHC Record A) for the patient 103. As shown in FIG. 1, such communication is achieved through network 106, although in some embodiment the general practitioner 105 may communicate directly with the records management and permissioning system 100. In the embodiment shown, communication is achieved through a professional portal 108 connected to network 106 which is connected to the records management and permissioning system 100. As a result, the first record 101 is maintained by the general practitioner 105, but is managed by the records management and permissioning system 100. In other words, the general practitioner 105 is responsible for the maintenance of the first record 101 and performs tasks such as updating information contained in the first record 101 and determining how the information is accessed. The record management and permissioning system 100 manages the first record, storing the information and providing access to the information to authorized users as directed by the general practitioner 105.

In addition, another entity such as the patient 103, communicates with the record management and permissioning system 100. In the embodiment of FIG. 1 the communication takes place through a patient access portal 111 which communicates with the records management and permissioning system 100 over the network. The patient 103 maintains a second record 102 (e.g., Personal Record) for the patient 103. For instance, the patient 103 may maintain the second record 102 for personal use, and may access the second record 102 through the patient access portal 111 that is separate from the professional portal 108. As an example, the patient 103 may maintain an immunization record relating to immunization shots given to the patient 103 over the years. In many cases, the personal accounting of immunization may be the most accurate, as the patient 103 may obtain one immunization from one medical professional and another immunization from a second medical professional. Records at each of the health care providers may not include all the immunization shots, while immunization record of the patient 103 probably contains all the immunization shots. The patient 103 would maintain the immunization record in the form of the second record 102 stored at the records management and permissioning system 100.

As shown, each of the records 101, 102 is managed by the records management and permissioning system 100 and maintained by at least one entity. The records 101, 102 are stored in a central database 107. The central database 107 may be connected directly to the record management and permissioning system 100 as shown in FIG. 1, or it could be connected to the network 106 and communicate with the record management and permissioning system 100 through the network 106.

In general, the records management and permissioning system 100 provides access to whatever entity is maintaining the record. For instance, general practitioner 110 maintains the first record 101 and the patient 103 maintains the second record 102. The record management and permissioning system 100 provides access to the first record 101 to the general practitioner 110 and any other entity that the general practitioner 110 authorizes. In that manner, it is as if the first record 101 was locally maintained in the offices of the general practitioner 110. In a similar manner, patient 103 maintains the second record 102 and determines what entities may access the second record 102. The record management and permissioning system 100 would then provide access to the second record 102 to the patient 103 and any entity that the patient 103 has authorized.

The records management and permissioning system 100 manages access to the first record 101 associated with the patient 103 and the health care provider, general practitioner 110, controls third party access to the first record 101. Using the example above, the first record 101 is managed by the record management and permissioning system 100 for the benefit of the general practitioner 110. In addition, the general practitioner 110 controls access to the first record 101, and may grant permission to another entity, such as the patient 103, to gain access to the first record 101.

Access to a record may further be defined by an entity maintaining the record. For example, general practitioner 110 may define access to the first record 101 to be limited to viewing some or all of the first record 101, and in that case, no modification of the first record 101 is allowed for the viewing party. The record management system would then allow a viewing party, such as surgical team 109, to view the record but would not allow the surgical team 109 to make any changes to the record. In addition, the general practitioner 110 may give permission allowing an entity, such as the patient 103, to modify the first record 101. The record management and permissioning system 100 would then allow the patient to modify the first record 101.

Similar access may be defined for the second record 102 by the entity maintaining the second record 102. The record management and permissioning system 100 would then allow access to the second record 102 based on the access defined by the entity maintaining the second record 102. For example, patient 103 controls third party access to the second record 102. That is, the second record 102 is managed for the benefit of the patient 103. In addition, the patient 103 controls access to the second record 102, and as such may grant permission to another entity, such as the general practitioner 110, to gain access to the second record 102. The patient 103 may allow the general practitioner to only read a portion of the second record 102, change only a portion of the second record 102, or other combinations of read and change access to all or portions of the second record 102. The permissions defined by the patient 103 would then be enforced by the record management and permissioning system 100.

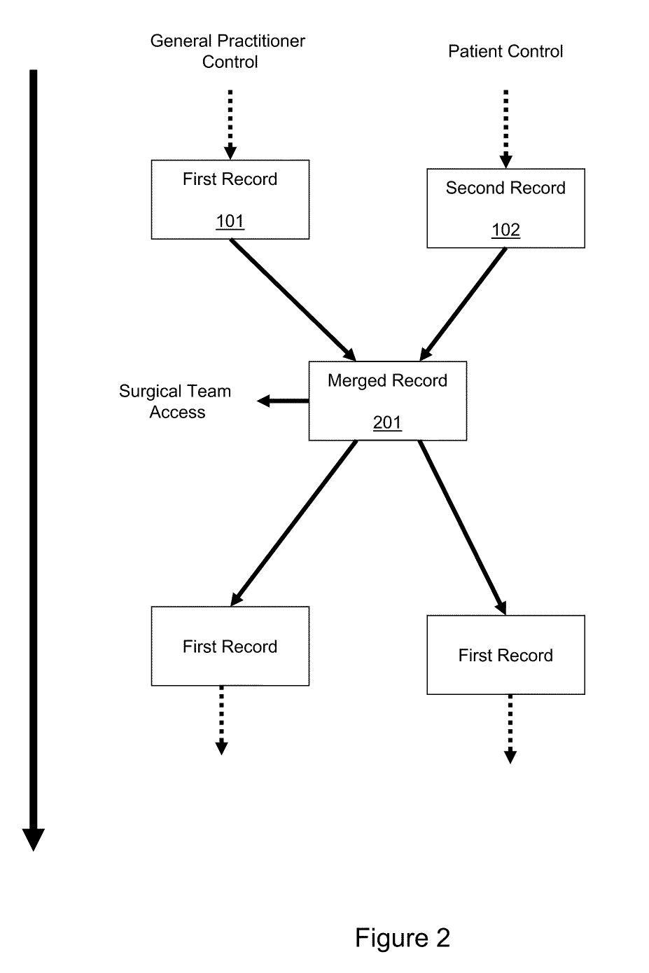

FIG. 2 is an illustration of merging and unmerging of records by the records management and permissioning system 100 of FIG. 1. In FIG. 2 the first record 101 is merged with the second record 102 by the records management and permissioning system 100. The first record 101 is maintained by the general practitioner 110, through the services of the records management and permissioning system 100. The general practitioner 110 is used as an example, but any entity maintaining the first record 101 would be applicable. In addition, the second record 102 is maintained by the patient 103 through the records management and permissioning system 100.

Normally, the two records 201, 202 are separate, and access to either record 201, 202 by their respective controlling entity is not granted to any third party. For example, the patient 103 is not granted access to the first record 101 maintained by the general practitioner 110, and the patient 103 can only receive a copy of the first record 101 upon request. Also, the general practitioner 110 is not given access to the second record 102, since it is in paper form and maintained at the residence of the patient 103.

However, in embodiments of the present invention, upon permission by the entity maintaining the record, access to records 101, 102 associated with the patient 103 may be granted such that the records 101, 102 are merged through the records management and permissioning system 100. For instance, the first record 101 and the second record 102 may be relationally linked during a period of time where the surgical team 109 is preparing for surgery, performing surgery, and conducting outpatient services for the patient 103.

In that case, it may be mutually beneficial for both records 101, 102 to be accessible by additional parties. For instance, the general practitioner 110 may maintain a medical history of the patient in the first record 101. The surgical team 109 would need to access the first record 101 to perform a surgical operation. In addition, the patient 103 may be aware of an allergic reaction to anesthesia because of a prior operation. Though certainly known to the patient 103, that information may not be in the first record and must be asked by the surgical team 109 and responded to by the patient 103. On the other hand, that information may already be logged and noted in the second record 102, that is maintained by the patient 103. As a result, by merging the first record 101 and the second record 102, and granting access to the first record 101 and second record 102, the surgical team 109 may view the combination of information contained therein. The surgical team 109 may learn of the allergic reaction to anesthesia immediately without querying the patient 103, and as such may act on that information in a shorter period of time.

As a result, as shown in FIG. 2, the two records 101, 102 are merged into a merged record 201. It is important to note that the merging is controlled through the granting of permissions by a record maintainer to access respective records. The permissions are then enforced by the record management and permissioning system 100. For instance, the patient 103 must grant permission for the surgical team 109 to access the second record 102, and the general practitioner 110 must also grant permission to the surgical team 109 to access the first record 101, during the period of mutual access of records.

In some embodiments, there is a granting of mutual access to the records between record maintainers. In one embodiment, the records management and permissioning system 100 aligns both records 101, 102 maintained within its system. That is, the records management and permissioning system 100 is able to analyze information contained within both records 101, 102 and align them accordingly. For instance, the first record 101 is updated with information from the second record 102. In addition, the second record 202 is updated with information from the first record 201.

In one embodiment, the records management and permissioning system 100 aligns the records 101, 102 by generating a separate merged record 201 with permissions appropriate to the granted mutual access. For instance, the first record 101 and the second record 102 are merged to form a merged record 201 which is maintained by both the general practitioner 105 and patient 103. The mutual access may be read only, write only, read and write, for a portion of the merged record depending on permissions requested by the original maintainer of that portion.

In another embodiment, the alignment is performed by each of the record maintainers. That is, the records management and permissioning system 100 provides access to each of the records 101, 102 by either record maintainer. As long as the scope of access as permissioned by the record maintainer and enforced by the record management and permissioning system 100, either record maintainer may go into any record, update information in both records 101, 102, and align information in both records 101, 102.

In addition, the records management and permissioning system 100 may maintain a master record (not shown) that includes updated information from both records. The master record may only include basic information associated with the patient 103, such as identifying information, contact information, etc. In other cases, the master record may include detailed information about the patient 103.

As such, during the period of mutual access, the merged record 201 includes some or all the information obtained from both the first record 101, and the second record 102. Alignment is performed to address inconsistencies between the two records 101, 102.

Also shown in FIG. 2 is a cancellation of mutual access. For example, the surgical procedure may have been completed and outpatient services performed, and as such, the patient 103 no longer wants the surgical team 109 to access the second record, and thus the patient 103 withdraws its permissions to the second record 102. As a result, the first record 101 and the second record 102 are again separate and maintained by separate entities, but are still managed by the same records management and permissioning system 100.

In embodiments where a merged record 201 was generated, the merged record 201 may simply be deleted. In some embodiments, prior to deletion of the merged record 201, any information changed in the merged record 201 is propagated back to the record that included the original information. For example, if the surgical team 109 made a change to the merged record 201 corresponding to the allergy to anesthesia, the records management and permissioning system 100 would update the second record 102 to reflect the changed information.

Systems and methods for providing document management is thus described. While the invention has been illustrated and described by means of specific embodiments, it is to be understood that numerous changes and modifications may be made therein without departing from the spirit and scope of the invention as defined in the appended claims and equivalents thereof. Furthermore, while the present invention has been described in particular embodiments, it should be appreciated that the present invention should not be construed as limited by such embodiments, but rather construed according to the below claims.

What is claimed:

1. A computer implemented method for providing document management, the method comprising:
providing a computer system having access to a storage medium, said storage medium storing a plurality of records associated with a patient;
causing said computer system to manage a first record from among said plurality of records, said patient controlling access to said first record;
causing said computer system to manage a second record from among said plurality of records, said second record being associated with a health care provider providing care to said patient, said health care provider controlling access to said second record;
receiving a first permission associated with said first record;
causing said computer system to enforce said first permission with regard to said first record;
receiving a second permission associated with said second record;
causing said computer system to enforce said second permission with regard to said second record; and
causing said computer system to store said first permission and said second permission.

2. The computer implemented method of claim 1, further comprising:
receiving an input requesting a merger of said first record and said second record; and
causing said computer system to merge said first record and said second record.

3. The computer implemented method of claim 2 wherein said causing said computer system to merge said first record and said second record includes generating a third record having said first record and said second record.

4. The computer implemented method of claim 2 wherein said first record has a first data and said second record has a second data and wherein said causing said computer system to merge said first record and said second record includes:
copying said first data to said second record; and
copying said second data to said first record.

5. The computer implemented method of claim 1, wherein said first record has a first data and said second record has a second data, the method further comprising:
causing said computer system to maintain a master record including said first data and said second data.

6. The computer implemented method of claim 3, the method further comprising:
receiving an input indicating a separation of said merged record; and
causing said computer system to delete said merged record.

7. The computer implemented method of claim 4, the method further comprising:
receiving an input indicating a separation of said merged record; and
causing said computer system to delete said first data from said second record; and
causing said computer system to delete said second data form said first record.

8. The computer implemented method of claim 3, the method further comprising:
receiving a third data to update to said merged record; and
causing said computer system to copy said third data to said first record.

9. A system for providing document management, the system comprising:
a database storing a plurality of records associated with a patient and a plurality of permissions associated with said plurality of records;
a permissions manager for controlling access to said plurality of records according to said plurality of permissions;
a manager configured to manage a first record from among said plurality of records, said patient controlling a first permission from said plurality of permission, said first permission associated with said first record, and configured to manage a second record from among said plurality of permissions, wherein a health care provider providing care to said patient controlling a second permission associated with said second record, and said manager being further configured to enforce said plurality of permissions.

10. The system of claim 9, wherein said manager is further configured to merge at least two records from among said plurality of records.

11. A computer storage medium comprising computer executable instructions that when executed by a processer cause a computing system to perform a method, the method comprising:
accessing a storage medium, said storage medium storing a plurality of records associated with a patient;
managing a first record from among said plurality of records, said patient controlling access to said first record;
managing a second record from among said plurality of records, said second record being associated with a health care provider providing care to said patient, said health care provider controlling access to said second record;
in response to receiving a first permission associated with said first record, enforcing said first permission with regard to said first record;
in response to receiving a second permission associated with said second record, enforcing said second permission with regard to said second record; and
storing said first permission and said second permission.

12. The computer storage medium of claim 11, wherein said method further comprises:
in response to receiving an input requesting a merging of said first record and said second record, merging said first record and said second record.

13. The computer storage medium of claim 12, wherein said merging said first record and said second record includes generating a third record having said first record and said second record.

14. The computer storage medium of claim 12, wherein said first record has a first data and said second record has a second data and wherein said merging said first record and said second record includes:
copying said first data to said second record; and
copying said second data to said first record.

15. The computer storage medium of claim 11, wherein said first record has a first data and said second record has a second data and wherein said method further comprises:
maintaining a master record including said first data and said second data.

16. The computer storage medium of claim 13, wherein said method further comprises:
in response to receiving an input indicating a separation of said merged record, deleting said merged record.

17. The computer storage medium of claim 14, wherein said method further comprises:
in response to receiving an input indicating a separation of said merged record, deleting said first information from said second record and deleting said second information from said first record.

18. The computer storage medium of claim 13, wherein said method further comprises:
in response to receiving a third data to update to said merged record, copying said third data to said first record.
